(19) United States
(12) Patent Application Publication
(10) Pub. No.: US 2023/0087022 A1
(43) Pub. Date: Mar. 23, 2023

(54) TEXT LANGUAGE TYPE SWITCHING METHOD AND APPARATUS, DEVICE, AND STORAGE MEDIUM

(71) Applicant: VIVO MOBILE COMMUNICATION CO., LTD., Dongguan (CN)

(72) Inventor: Mengjie ZHENG, Dongguan (CN)

(73) Assignee: VIVO MOBILE COMMUNICATION CO., LTD., Dongguan (CN)

(21) Appl. No.: 17/993,866

(22) Filed: Nov. 23, 2022

Related U.S. Application Data
(63) Continuation of application No. PCT/CN2021/096190, filed on May 26, 2021.

(30) Foreign Application Priority Data
May 28, 2020 (CN) 202010471772.9

(51) Int. Cl. G06F 3/023; G06F 40/263

(52) U.S. Cl. CPC G06F 3/0237; G06F 40/263

(57) ABSTRACT

A text language type switching method and apparatus, a device, and a non-transitory computer-readable storage medium are provided. The method includes: receiving a typing input of a user; displaying a first text segment in response to the typing input; receiving a first input of the user; determining a to-be-switched text segment of a first language type from the first text segment in response to the first input; receiving a second input of the user; and switching the to-be-switched text segment to a target text segment of a second language type in response to the second input.

### CROSS-REFERENCE TO RELATED APPLICATIONS

This application is a continuation of International Application No. PCT/CN2021/096190, filed on May 26, 2021, which claims priority to Chinese Patent Application No. 202010471772.9, filed on May 28, 2020. The entire contents of each of the above-referenced applications are expressly incorporated herein by reference.

### TECHNICAL FIELD

The present disclosure relates to the field of electronic devices, and specifically, to a text language type switching method, a text language type switching apparatus, an electronic device, and a readable storage medium.

### BACKGROUND

With the development of science and technology, working or communicating with electronic devices such as a mobile phone and a computer has become an important part of people's lives. During working or communicating by using the electronic device such as a mobile phone or a computer, text needs to be entered by using an input method.

In a case that a user enters text by using the input method, there is a case that the user is not aware in time that a language type of currently entered text is not expected. Consequently, the user realizes that the language type of the currently entered text is incorrect after a long of text is entered. In this case, the user can only delete a large segment of entered text of an unexpected language type, and then edit the text again. Consequently, the user adds a large quantity of unnecessary editing operations, thereby reducing editing experience of the user.

### SUMMARY

This application provides a text language type switching method and apparatus, a device, and a storage medium.

The present disclosure is implemented as follows:

According to a first aspect, a text language type switching method is provided, and the method includes: receiving a typing input of a user; displaying a first text segment in response to the typing input; receiving a first input of the user; determining a to-be-switched text segment of a first language type from the first text segment in response to the first input; receiving a second input of the user; and switching the to-be-switched text segment to a target text segment of a second language type in response to the second input.

According to a second aspect, a text language type switching apparatus is provided, and the switching apparatus includes: a first receiving module, configured to receive a typing input of a user; a first responding module, configured to display a first text segment in response to the typing input; a second receiving module, configured to receive a first input of the user; a second responding module, configured to determine a to-be-switched text segment of a first language type from the first text segment in response to the first input; a third receiving module, configured to receive a second input of the user; and a third responding module, configured to switch the to-be-switched text segment to a target text segment of a second language type in response to the second input.

According to a third aspect, an electronic device is provided, including: a processor, a memory, and a program or an instruction that is stored in the memory and that can run on the processor, where in a case that the program or the instruction is executed by the processor, steps in the text language type switching method according to the first aspect are implemented.

According to a fourth aspect, a readable storage medium is provided, where the readable storage medium stores a program or an instruction, and in a case that the program or the instruction is executed by a processor, steps in the text language type switching method according to the first aspect are implemented.

### BRIEF DESCRIPTION OF DRAWINGS

The accompanying drawings, which are incorporated in the specification and constitute a part of the specification, illustrate embodiments of this application and are used together with the description thereof to explain the principles of the present disclosure.

FIG. 1 is a first interface display diagram of an electronic device according to an embodiment of this application;

FIG. 2 is a schematic flowchart of a text language type switching method according to an embodiment of this application;

FIG. 3 is a second interface display diagram of an electronic device according to an embodiment of this application;

FIG. 4 is a third interface display diagram of an electronic device according to an embodiment of this application;

FIG. 5 is a fourth interface display diagram of an electronic device according to an embodiment of this application;

FIG. 6 is a fifth interface display diagram of an electronic device according to an embodiment of this application;

FIG. 7 is a sixth interface display diagram of an electronic device according to an embodiment of this application;

FIG. 8 is a schematic structural diagram of an electronic device according to an embodiment of this application;

FIG. 9 is a schematic diagram of a hardware structure of an electronic device for implementing embodiments of this application; and

FIG. 10 is a schematic diagram of a structure of another electronic device according to an embodiment of this application.

### DETAILED DESCRIPTION

The following describes the technical solutions in the embodiments of this application with reference to the accompanying drawings in the embodiments of this application. Apparently, the described embodiments are some rather than all of the embodiments of this application. According to the embodiments of this application, all other embodiments obtained by a person of ordinary skill in the art without creative efforts fall within the protection scope of this application.

Terms “first” and “second” in the specification and claims of this application are used to distinguish between similar objects, and do not need to be used to describe a specific order or sequence. It should be understood that data used in this way may be interchangeable in appropriate cases, so that the embodiments of this application can be implemented in a sequence other than those shown or described herein. In addition, in the specification and the claims, “and/or” represents at least one of connected objects, and the character “I” generally represents an “or” relationship between associated objects.

A text language type switching method provided in the embodiments of this application is described in detail below with reference to the accompanying drawings by using embodiments and application scenarios thereof.

An embodiment of this application provides a text language type switching method, and the method may be executed by various electronic devices, for example, any device that can input text, such as a mobile phone, a tablet computer, a notebook computer, a palmtop computer, an in-vehicle terminal, or a wearable device.

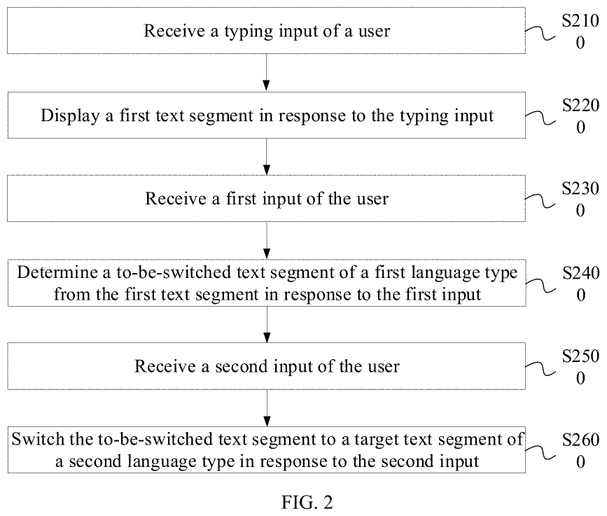

As shown in FIG. 2, the method includes the following S2100 to S2600.

S2100: Receive a typing input of a user.

S2200: Display a first text segment in response to the typing input.

In this embodiment of this application, the typing input of the user may be an operation of selecting at least one button on a keyboard of an electronic device in a case that the user edits text. The keyboard may be a push-button keyboard, or may be a touch keyboard.

In this embodiment of this application, the user performs the typing input. After receiving the typing input of the user, the electronic device responds to the typing input to identify the at least one button selected by the user. Further, the electronic device displays a matched text segment according to information corresponding to the identified button, that is, a first text segment in this embodiment of this application.

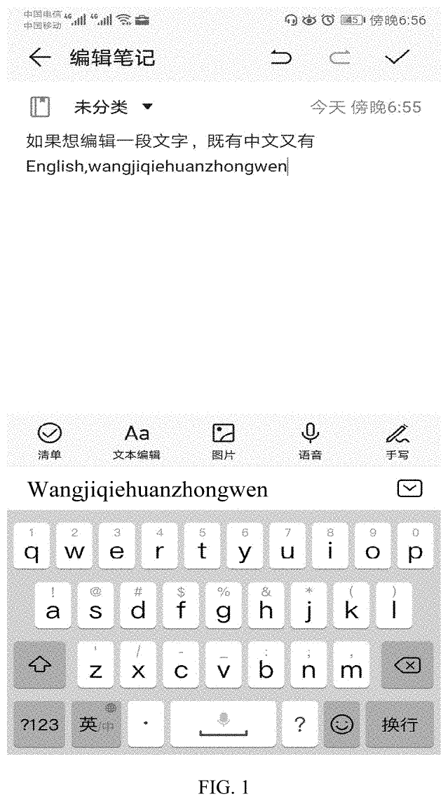

For example, text to be edited by the user by using an input method is (in Chinese) “ [symbol] , [symbol] English, [symbol] ” (the sentence means, in English, “if one wants to edit a paragraph of texts, including both Chinse and English, and forgets to switch to Chinse input type”). In order to type the word “English” within the sentence in Chinese, the user has to switch a language type from Chinese to English. After the word “English” is input, the user may forget to switch a language type from English back to Chinese. Consequently, the remaining Chinese sentence will be typed in English letters. As shown in FIG. 1, a piece of text that is actually edited by using the input method becomes “ [symbol] , [symbol] , [symbol] English,wangjiqiehuanzhongwen”. In the example shown in FIG. 1, the first text segment is “ [symbol] , [symbol] English,wangjiqiehuanzhongwen”.

S2300: Receive a first input of the user.

In this embodiment of this application, the first input of the user is an operation that the user selects an input text segment of an unexpected language type from the first text segment. In this embodiment of this application, the input text segment of the unexpected language type is referred to as a to-be-switched text segment.

With reference to the example described in FIG. 1, the to-be-switched text segment is “wangjiqiehuanzhongwen” input by the user because the user forgets to switch a language type.

S2400: Determine a to-be-switched text segment of a first language type from the first text segment in response to the first input.

In this embodiment of this application, the first language type is the unexpected language type of the user.

In an embodiment, the electronic device may separately display a cursor “1” on each side of the determined to-be-switched text segment, to prompt the user of a specific location of the to-be-switched text segment.

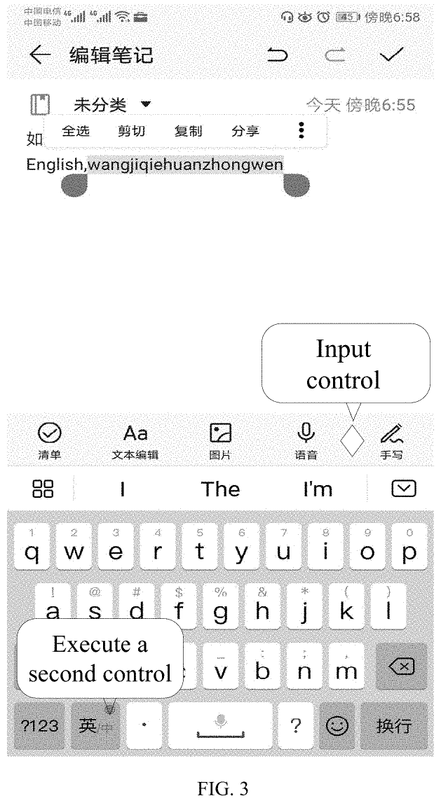

In some embodiments, as shown in FIG. 3, a rectangular frame with a grayscale is displayed on above the determined to-be-switched text segment, and waterdrop cursors are displayed on both sides, to prompt the user of a specific location of the to-be-switched text segment.

In this embodiment of this application, the first text segment includes at least two sub-text segments that are sequentially input by the user. It may be understood that the to-be-switched text segment is a sub-text segment in the first text segment. One sub-text segment is a text segment that is consecutively input by the user at one time.

For example, if an input of the user is the first text segment “ [symbol] , [symbol] English,wangjiqiehuanzhongwen”, after entering “ruguoxiang”, the user taps the Enter key or the Space key or taps 1, and “ruguoxiang” is displayed as “ [symbol] ”. Further, after entering “bianjiyiduan”, the user taps 2, and “bianjiyiduan” is displayed as “ [symbol] ”. Further, after entering “wenzi”, the user taps the Enter key or the Space key or taps 1, and “wenzi” is displayed as “ [symbol] ”. Further, after entering “jiyou”, the user taps the Enter key or the Space key or taps 1, and “jiyou” is displayed as “ [symbol] ”. Further, after entering “zhongwen”, the user taps the Enter key or the Space key or taps 1, and “zhongwen” is displays as “ [symbol] ”. Further, after entering “youyou”, the user taps the Enter key or the Space key or taps 1, and “youyou” is displayed as “ [symbol] ”, and then taps a conversion key “shift” to convert Chinese into English. Further, after entering “english”, the user taps the Enter key or the Space key, and “English” is displayed as “English”, and then the user enters a comma. The user forgets to tap “shift” to convert Chinese into English, and in this case, the user enters “wangjiqiehuanzhongwen”. In this case, sub-text segments that are sequentially input by the user may be obtained: “ [symbol] ”, “ [symbol] [symbol] ”, “ [symbol] ”, “ [symbol] ”, “ [symbol] ”, “English”, and “wangjiqiehuanzhongwen”.

In an embodiment of this application, an implementation of S2400 may be implemented as the following S2410:

S2410: Determine, according to a target type of the first input, a target sequence number corresponding to the target type, and determine a sub-text segment corresponding to the target sequence number that is in the at least two sub-text segments as the to-be-switched text segment.

In an embodiment of this application, the target type of the first input may be a quantity of input times of the first input. Correspondingly, the target sequence number corresponding to the target type is a specific quantity of input times of the first input.

In another embodiment of this application, the target type of the first input may be a sliding distance, a sliding direction, a sliding speed, or the like corresponding to the first input. Correspondingly, the target sequence number corresponding to the target type may be a specific sliding distance value, a specific sliding direction, a specific sliding speed, or the like corresponding to the first input. It may be understood that a corresponding target sequence number is also different in a case that a specific sliding distance value, a specific sliding direction, or a specific sliding speed is different.

For example, in a case that the target type of the first input is the sliding distance of the first input, for example, if the sliding distance is a sliding distance less than 0.5 cm, it is determined that the target sequence number is 1. If the sliding distance is between 0.5 cm and 1 cm, it is determined that the target sequence number is 2.

In this embodiment of this application, different target sequences correspond to different sub-text segments in the first text segment.

In an embodiment of this application, a sub-text segment whose reverse sequence number is the same as the target sequence number in the first text segment may be used as the sub-text segment corresponding to the target sequence number.

In some embodiments, a sub-text segment whose sequence number is the same as the target sequence number in the first text segment may be used as the sub-text segment corresponding to the target sequence number. In this embodiment, the first text segment may be a preset quantity of latest sub-text segments that are sequentially input by the user.

It may be learned from the foregoing content that the text language type switching method provided in this embodiment of this application further includes a step of determining a sub-text segment, and the step is the following S2411:

S2411: In a case that an input event of acknowledgment text is monitored, determine, as one sub-text segment, text between currently latest input text and text that is input for the first time after the input event is previously monitored.

In this embodiment of this application, the input event of the acknowledgement text may be an event such as an event of tapping the Space key, an event of tapping the Enter key, or an event of tapping the number key 1, 2, 3, 4, or 5.

Based on S2410, in a case that the electronic device is an electronic device according to a touch keyboard, in the text language type switching method provided in this embodiment of this application, an input control used by the user to input the first input may be further provided. The user may tap the input control at least once to implement execution of the first input. In some embodiments, a sliding operation may be performed on the input control to implement execution of the first input.

In an embodiment of this application, the input control may be a newly added control disposed within a range of a touch keyboard corresponding to an input method. For example, the input control may be shown in FIG. 3.

In a case that the electronic device is an electronic device according to a push-button keyboard, in the text language type switching method provided in this embodiment of this application, a combined shortcut key and a key for selecting a to-be-switched text segment may be further provided for the user to enter the first input.

In this embodiment, the electronic device identifies a pressing operation for the combined shortcut key as the first input in the first time, and after identifying the first input in the first time, the electronic device identifies a pressing operation on the key for selecting the to-be-switched text segment as the first input in the second time or more.

In this embodiment of this application, the combined shortcut key may be set by the user in Settings in a soft keyboard of the electronic device, and the key for selecting the to-be-switched text segment may be a key with a left arrow.

S2500: Receive a second input of the user.

In this embodiment of this application, the second input is used to instruct to switch the to-be-switched text segment to a target text segment of a second language type. The second language type is an expected language type of the user.

In an example, the second input of the user may be an operation of tapping the “shift” key by the user.

In another example, in a case that the first language type is Chinese and the second language type is English, as shown in FIG. 3, the second input of the user may be an operation of tapping the “Chinese or English” key by the user.

S2600: Switch the to-be-switched text segment to a target text segment of a second language type in response to the second input.

It may be understood that the to-be-switched text segment of the first language type and the target text segment of the second language type correspond to a same typing input of the user. In other words, the to-be-switched text segment is the same as an original text segment of the target text segment. Therefore, the electronic device may obtain, according to the original text segment of the to-be-switched text segment, the target text segment corresponding to the to-be-switched text segment.

Based on the foregoing content, in an embodiment, the foregoing S2200 further includes the following step S2210:

S2210: Determine an original text segment according to the first typing sub-input, and determine the to-be-switched text segment of the first language type corresponding to the original text segment.

In implementation of this application, the first typing input includes multiple typing sub-inputs. Each typing sub-input corresponds to one original text segment, and one original text segment corresponds to one sub-text segment in the first text segment. A typing sub-input corresponding to the to-be-switched text segment is recorded as the first sub-input. The original text segment in S2210 is an original text segment corresponding to the first sub-input.

In implementation of this application, the electronic device may record an original text segment corresponding to a preset quantity of typing sub-inputs that are executed by the user.

Based on S2210, an implementation of S2600 may be S2610.

S2610: Determine, according to the original text segment corresponding to the to-be-switched text segment, a target text segment of the second language type corresponding to the original text segment.

For example, in a case that the first language type is English, the to-be-switched text segment is an original text segment, and in a case that the second language type is English, the target text segment is an original text segment.

In this embodiment of this application, in a case that the original text segment is consistent with text composition of the second language type, an implementation of S2610 may be: using, as the target text segment of the second language type, the original text segment corresponding to the to-be-switched text segment.

For example, if the first language type is Chinese, the original text segment corresponding to the to-be-switched text segment of the first language type is “abcdef”, and the second language type is English, “abcdef” is an English text segment expected to be input by the user, that is, the target text segment of the second language type. In this case, the original text segment corresponding to the to-be-switched text segment is a text segment of the second language type expected by the user. Therefore, the original text segment corresponding to the to-be-switched text segment is directly used as the target text segment of the second language type.

In this embodiment of this application, in a case that the original text segment corresponds to a text segment of at least one second language type, an implementation of S2610 may be the following S2611 to S2613:

S2611: Display the text segment of at least one second language type that matches the original text segment corresponding to the to-be-switched text segment.

S2612: Receive a third input of the user.

In this embodiment of this application, the third input of the user is an operation of selecting the target text segment of the second language type from the text segment of at least one second language type by the user.

S2613: Determine the target text segment of the second language type from the text segment of at least one second language type in response to the third input.

In an example, if the first language type is English, and the corresponding to-be-switched text segment is “wdjx”, the original text segment of the to-be-switched text segment is “wdjx”. In a case that the second language type is Chinese, the original text segment “wdjx” of the to-be-switched text segment corresponding to a text segment of at least one second language type may be “ [symbol] ”, “ [symbol] ”, or the like. The user may execute the third input, to select the target text segment of the second language type from the text segment of at least one second language type. The electronic device determines the target text segment of the second language type from the text segment of at least one second language type. in response to the third input

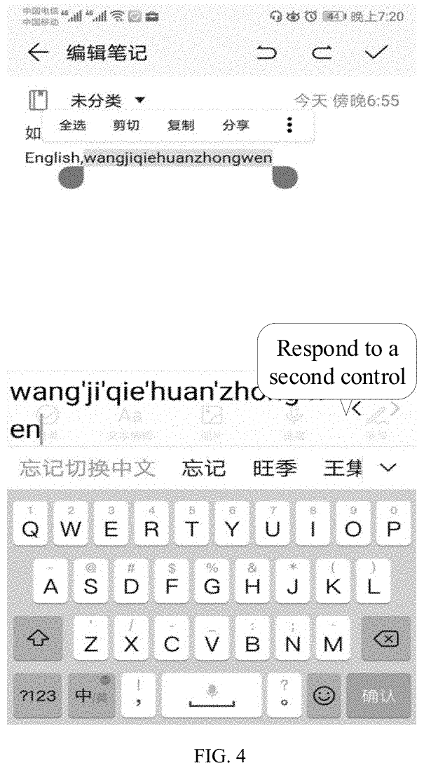

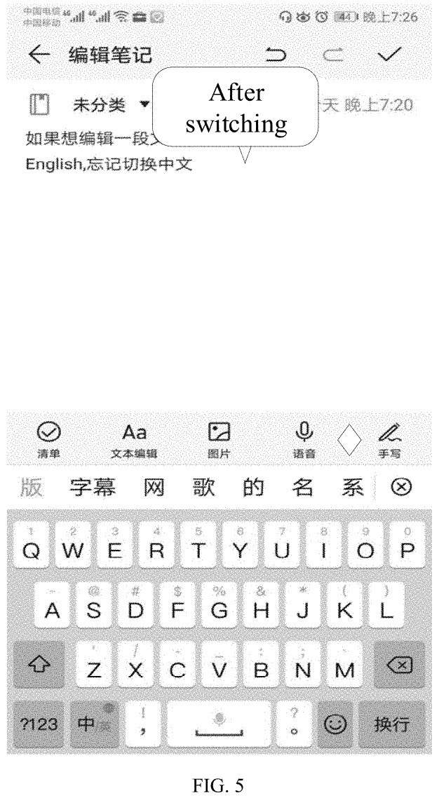

In addition, with reference to the example shown in FIG. 1, after the electronic device performs S2600, as shown in FIG. 4, the to-be-switched text segment “wangjiqiehuanzhongwen” of the first type may be displayed, and a corresponding target text segment of the second language type is “ [symbol] ”. Further, the electronic device may directly replace “wangjiqiehuanzhongwen” in the first text segment with “ [symbol] ”, and an effect is shown in FIG. 5.

Based on any one of the foregoing embodiments, after switching the to-be-switched text segment to the target text segment of the second language type, the electronic device may further switch the cursor to the end of the displayed text segment, to prevent the user from manually switching the cursor to the end of the displayed text segment. Based on this, the foregoing S2600 may be shown in the following S2620:

S2620: Switch the to-be-switched text segment to a target text segment of the second language type, and switch a cursor to the end of a displayed text segment in response to the second input.

In this embodiment of this application, after switching the to-be-switched text segment to the target text segment of the second language type, the electronic device controls the cursor to automatically switch to the end of the displayed text segment. In this case, a text input location is at the end of the displayed text segment. In this way, the user can continue to perform typing input without manually moving the cursor to the end of the displayed text segment. This further improves editing experience of the user.

The displayed text segment is a text segment formed after the to-be-switched text segment in the first text segment is switched to the target text segment.

In this embodiment of this application, the cursor may be switched to the end of the displayed text segment in another manner.

For example, according to the foregoing example of the combined shortcut key, after the electronic device switches the to-be-switched text segment to the target text segment of the second language type, if the user triggers the combined shortcut key again, the electronic device controls the cursor to switch to the end of the displayed text segment.

For example, according to the foregoing example of the input control, after the electronic device switches the to-be-switched text segment to the target text segment of the second language type, if the user taps the input control again, the electronic device controls the cursor to switch to the end of the displayed text segment.

Based on any one of the foregoing embodiments, the text language type switching method provided in this embodiment of this application further includes: controlling the electronic device to switch the first language type to the second language type. In this embodiment, before the user performs the typing input again, a language type does not need to be manually switched. This further improves editing experience of the user.

In this embodiment of this application, a typing input of a user is received, and a first text segment is displayed in response to the typing input; a first input of the user is received; a to-be-switched text segment of a first language type is determined from the first text segment in response to the first input; a second input of the user is received; and the to-be-switched text segment is switched to a target text segment of a second language type in response to the second input. In this way, only the first input needs to be performed by the user, so that the to-be-switched text segment of the first language type may be selected, and then one second input is performed, so that the to-be-switched text segment of the first language type may be switched to the target text segment of the second language type. In this way, an editing operation performed again by the user is avoided, that is, a large quantity of unnecessary editing operations performed by the user are avoided, thereby improving editing experience of the user.

Based on the foregoing embodiment, in the text language type switching method provided in this embodiment of this application, text may also be edited again. For example, in a case that the user is dissatisfied with some sub-text segments in the first text segment, the dissatisfied text segment may be considered as he to-be-switched text segment and is determined by using the foregoing S2400. Then, the user can edit the text again. Finally, the electronic device replaces the text segment that is not satisfied by the user with a re-edited text segment. Based on this, the text language type switching method provided in this embodiment of this application may further include the following steps:

S2710: Receive a fourth input of the user.

In this embodiment of this application, the fourth input is the same as the first input, and details are not described herein again.

S2720: Determine a to-be-edited text segment in the first text segment in response to the fourth input.

S2730: Determine a text segment re-edited by the user, and replace the to-be-edited text segment with the re-edited text segment.

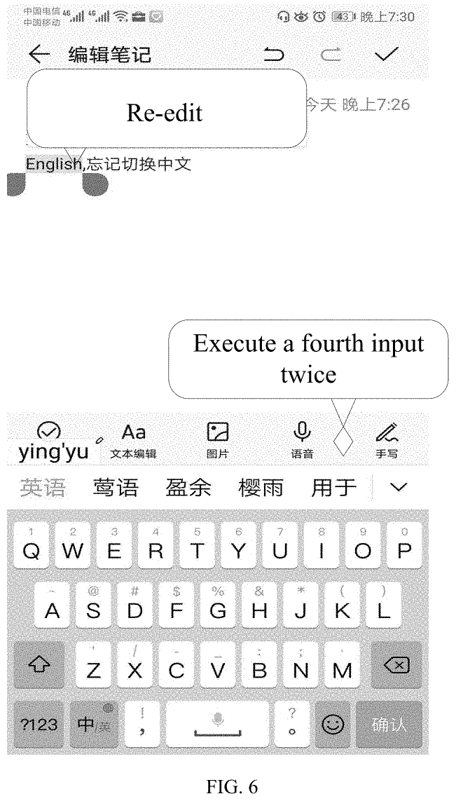

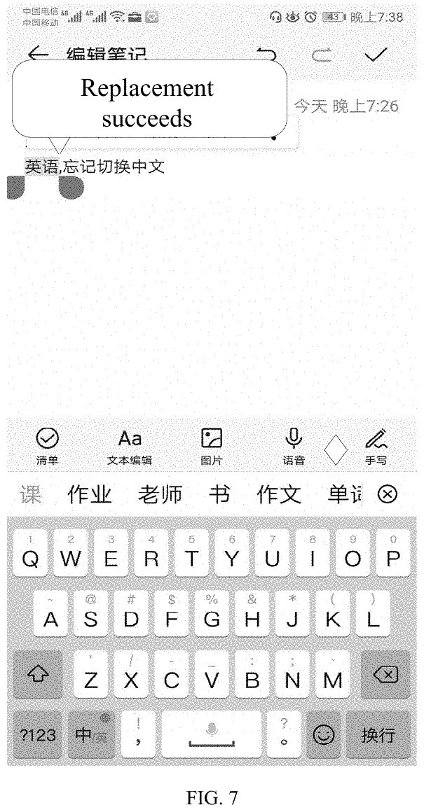

For example, as shown in FIG. 6, in a case that the first text segment is “ [symbol] [symbol] , [symbol] English, [symbol] ”, if the user is not satisfied with the last second input sub-text segment “English”, the user may execute the fourth input twice. The electronic device determines “English” in the first text segment as a to-be-edited text segment in response to the fourth input. The user re-edits the text segment “English”. In this case, as shown in FIG. 7, the electronic device replaces “English” with “ [symbol] ”.

Based on any one of the foregoing embodiments, after replacing the to-be-edited text segment with the re-edited text segment, the electronic device may further switch the cursor to the end of the displayed text segment, to prevent the user from manually switching the cursor to the end of the displayed text segment. Based on this, the foregoing S2730 may be shown in the following S2731:

S2731: Determine a text segment re-edited by the user, replace a to-be-edited text segment with the re-edited text segment, and switch the cursor to the end of the displayed text segment.

In this embodiment of this application, after replacing the to-be-edited text segment with the re-edited text segment, the electronic device controls the cursor to automatically switch to the end of the displayed text segment. In this case, a text input location is at the end of the displayed text segment. In this way, the user can continue to perform typing input without manually moving the cursor to the end of the displayed text segment. This further improves editing experience of the user.

The displayed text segment is a text segment formed after the to-be-switched text segment in the first text segment is switched to re-edited text.

In this embodiment of this application, the cursor may be switched to the end of the displayed text segment in another manner.

For example, according to the foregoing example of the combined shortcut key, after the electronic device replaces the to-be-edited text segment with the re-edited text segment, if the user triggers the combined shortcut key again, the electronic device controls the cursor to switch to the end of the displayed text segment.

For example, according to the foregoing example of the input control, after the electronic device replaces the to-be-edited text segment with the re-edited text segment, if the user taps the input control again, the electronic device controls the cursor to switch to the end of the displayed text segment.

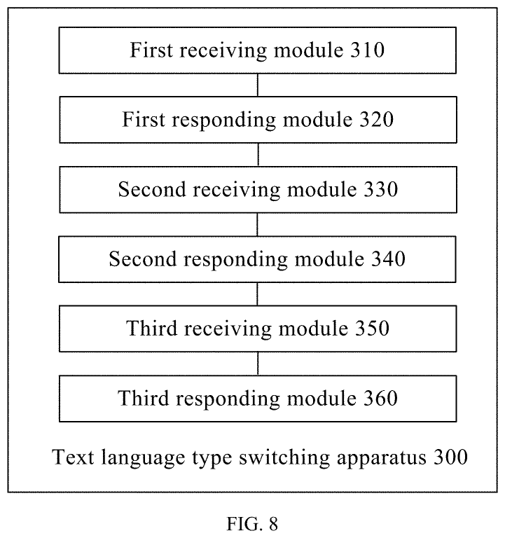

An embodiment of this application provides a text language type switching apparatus 300. As shown in FIG. 8, the apparatus 300 includes a first receiving module 310, a first responding module 320, a second receiving module 330, a second responding module 340, a third receiving module 350, and a third responding module 360.

The first receiving module 310 is configured to receive a typing input of a user.

The first responding module 320 is configured to display a first text segment in response to the typing input.

The second receiving module 330 is configured to receive a first input of the user.

The second responding module 340 is configured to determine a to-be-switched text segment of a first language type from the first text segment in response to the first input.

The third receiving module 350 is configured to receive a second input of the user.

The third responding module 360 is configured to switch the to-be-switched text segment to a target text segment of a second language type in response to the second input.

In an embodiment, the typing input includes a first typing sub-input.

The first responding module 320 is configured to: determine an original text segment according to the first typing sub-input, and determine the to-be-switched text segment of the first language type corresponding to the original text segment.

The third responding module 360 is configured to determine, according to the original text segment corresponding to the to-be-switched text segment, a target text segment of the second language type corresponding to the original text segment.

In an embodiment, in a case that the first language type is English, the to-be-switched text segment is the original text segment; and in a case that the second language type is English, the target text segment is the original text segment.

In an embodiment, in a case that the original text segment corresponds to a text segment of at least one second language type, the third responding module 360 includes a display unit, a receiving unit, and a responding unit.

The display unit is configured to display the text segment of at least one second language type that matches the original text segment corresponding to the to-be-switched text segment.

The receiving unit is configured to receive third input of the user.

The responding unit is configured to determine the target text segment of the second language type from the text segment of at least one second language type in response to the third input.

In an embodiment, the first text segment includes at least two sub-text segments that are sequentially input by the user, and the second responding module 340 is configured to:

determine, according to a target type of the first input, a target sequence number corresponding to the target type, and determine a sub-text segment corresponding to the target sequence number that is in the at least two sub-text segments as the to-be-switched text segment.

In an embodiment, the apparatus 300 further includes a determining module, configured to:

in a case that an input event of acknowledgment text is monitored, determine, as one sub-text segment, text between currently latest input text and text that is input for the first time after the input event is previously monitored.

In an embodiment, the third responding module is configured to:

switch the to-be-switched text segment to a target text segment of the second language type, and switch a cursor to the end of a displayed text segment in response to the second input.

The text language type switching apparatus 300 provided in this embodiment of this application can implement processes implemented by the electronic device in the method embodiment of FIG. 2. To avoid repetition, details are not described herein again.

In this embodiment of this application, the first receiving module receives a typing input of a user, and the first responding module displays a first text segment in response to the typing input; the second receiving module receives a first input of the user; the second responding module determines a to-be-switched text segment of a first language type from the first text segment in response to the first input; the third receiving module receives a second input of the user; and the third responding module switches the to-be-switched text segment to a target text segment of a second language type in response to the second input. In this way, only the first input needs to be performed by the user, so that the to-be-switched text segment of the first language type may be selected, and then one second input is performed, so that the to-be-switched text segment of the first language type may be switched to the target text segment of the second language type. In this way, an editing operation performed again by the user is avoided, that is, a large quantity of unnecessary editing operations performed by the user are avoided, thereby improving editing experience of the user.

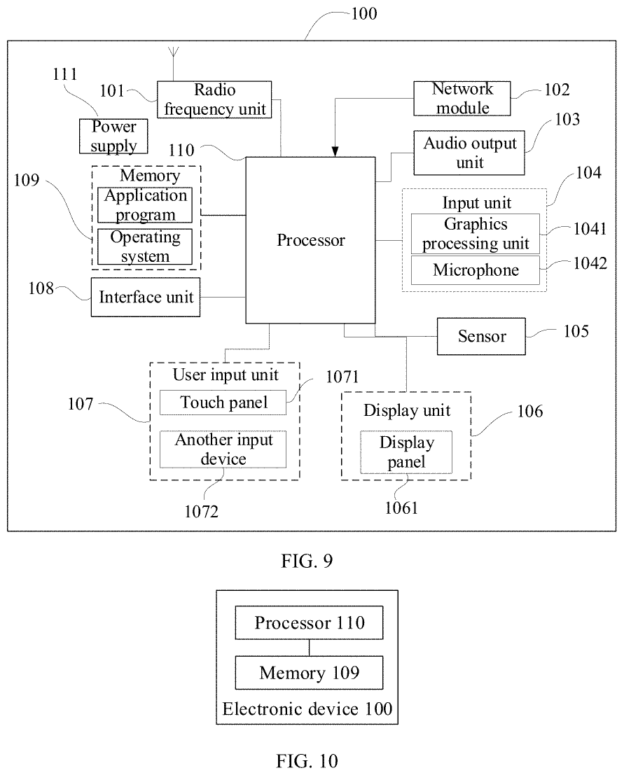

FIG. 9 is a schematic diagram of a hardware structure of an electronic device for implementing the embodiments of the present disclosure. The electronic device 100 includes but is not limited to components such as a radio frequency unit 101, a network module 102, an audio output unit 103, an input unit 104, a sensor 105, a display unit 106, a user input unit 107, an interface unit 108, a memory 109, a processor 110, and a power supply 111. A person skilled in the art may understand that a structure of the electronic device shown in FIG. 1 does not constitute a limitation on the electronic device, and the electronic device may include more or fewer components than those shown in the figure, or combine some components, or have different component arrangements. In this embodiment of the present disclosure, the electronic device includes but is not limited to a mobile phone, a tablet computer, a laptop computer, a palmtop computer, an in-vehicle terminal, a wearable device, and the like.

The user input unit 107 is configured to receive a typing input of a user.

The display unit 106 is configured to display a first text segment in response to the typing input.

The user input unit 107 is further configured to receive a first input of the user.

The processor 110 is configured to determine a to-be-switched text segment of a first language type from the first text segment in response to the first input.

The user input unit 107 is further configured to receive a second input of the user.

The processor 110 is further configured to switch the to-be-switched text segment to a target text segment of a second language type in response to the second input.

In this embodiment of this application, the user input unit receives a typing input of a user; the display unit displays a first text segment in response to the typing input; the user input unit receives a first input of the user; the processor determines a to-be-switched text segment of a first language type from the first text segment in response to the first input; the user input unit receives a second input of the user; and the processor switches the to-be-switched text segment to a target text segment of a second language type in response to the second input. In this way, only the first input needs to be performed by the user, so that the to-be-switched text segment of the first language type may be selected, and then one second input is performed, so that the to-be-switched text segment of the first language type may be switched to the target text segment of the second language type. In this way, an editing operation performed again by the user is avoided, that is, a large quantity of unnecessary editing operations performed by the user are avoided, thereby improving editing experience of the user.

It should be understood that, in this embodiment of the present disclosure, the radio frequency unit 101 may be configured to receive and send information or receive and send a signal in a call process. For example, after downlink data from a base station is received, the processor 110 processes the downlink data. In addition, uplink data is sent to the base station. Generally, the radio frequency unit 101 includes but is not limited to an antenna, at least one amplifier, a transceiver, a coupler, a low noise amplifier, a duplexer, and the like. In addition, the radio frequency unit 101 may further communicate with a network and another device by using a wireless communication system.

The electronic device provides wireless broadband Internet access for the user by using the network module 102, for example, helping the user send and receive an email, browse a web page, and access streaming media.

The audio output unit 103 may convert audio data received by the radio frequency unit 101 or the network module 102 or stored in the memory 109 into an audio signal and output as sound. In addition, the audio output unit 103 may further provide audio output (for example, call signal receiving sound or message receiving sound) related to a specific function performed by the electronic device 100. The audio output unit 103 includes a speaker, a buzzer, a telephone receiver, and the like.

The input unit 104 is configured to receive an audio or video signal. The input unit 104 may include a Graphics Processing Unit (GPU) 1041 and a microphone 1042. The graphics processing unit 1041 processes image data of a static picture or a video obtained by an image capture apparatus (such as a camera) in a video capture mode or an image capture mode. The processed image frame may be displayed on the display unit 106. The image frame processed by the graphics processing unit 1041 may be stored in the memory 109 (or another storage medium) or sent by using the radio frequency unit 101 or the network module 102. The microphone 1042 may receive sound and can process such sound into audio data. The processed audio data may be output by being converted into a format that may be sent to a mobile communications base station by using the radio frequency unit 101 in a telephone call mode.

The electronic device 100 further includes at least one sensor 105, such as an optical sensor, a motion sensor, and another sensor. For example, the optical sensor includes an ambient light sensor and a proximity sensor. The ambient light sensor may adjust luminance of a display panel 1061 according to brightness of ambient light, and the proximity sensor may disable the display panel 1061 and/or backlight in a case that the electronic device 100 approaches an ear. As a type of the motion sensor, an accelerometer sensor may detect magnitude of an acceleration in each direction (generally three axes), and may detect magnitude and a direction of gravity in a case of being static. The accelerometer sensor may be used for recognizing an electronic device gesture (for example, horizontal and vertical screen switching, a related game, or magnetometer posture calibration), a function related to vibration recognition (for example, a pedometer or a strike), or the like. The sensor 105 may further include a fingerprint sensor, a pressure sensor, an iris sensor, a molecular sensor, a gyroscope, a barometer, a hygrometer, a thermometer, an infrared sensor, and the like. This is not described herein.

The display unit 106 is configured to display information input by the user or information provided for the user. The display unit 106 may include a display panel 1061, and the display panel 1061 may be configured in a form of a Liquid Crystal Display (LCD), an Organic Light-Emitting Diode (OLED), or the like.

The user input unit 107 may be configured to receive input digit or character information and generate key signal input related to user setting and function control of the electronic device. For example, the user input unit 107 includes a touch panel 1071 and another input device 1072. The touch panel 1071, also referred to as a touchscreen, may collect a touch operation performed by the user on or near the touch panel 1071 (for example, an operation performed by the user on or near the touch panel 1071 by using any suitable object or accessory such as a finger or a stylus). The touch panel 1071 may include two parts: a touch detection apparatus and a touch controller. The touch detection apparatus detects a touch location of the user, detects a signal brought by the touch operation, and transmits the signal to the touch controller. The touch controller receives touch information from the touch detection apparatus, converts the touch information into contact coordinates, sends the contact coordinates to the processor 110, and can receive and execute a command sent by the processor 110. In addition, the touch panel 1071 may be implemented by using multiple types such as a resistive type, a capacitive type, an infrared ray, and a surface acoustic wave. The user input unit 107 may include another input device 1072 in addition to the touch panel 1071. For example, the another input device 1072 may include but is not limited to one or more of a physical keyboard, a function key (such as a volume control key or an on/off key), a trackball, a mouse, a joystick, and the like. Details are not described herein.

Further, the touch panel 1071 may cover the display panel 1061. After detecting the touch operation on or near the touch panel 1071, the touch panel 1061 transmits the touch operation to the processor 110 to determine a type of a touch event, and then the processor 110 provides corresponding visual output on the display panel 1061 according to the type of the touch event. In FIG. 9, the touch panel 1071 and the display panel 1061 are used as two independent components to implement input and output functions of the electronic device. However, in some embodiments, the touch panel 1071 and the display panel 1061 may be integrated to implement the input and output functions of the electronic device. This is not specifically limited herein.

The interface unit 108 is an interface connecting an external apparatus to the electronic device 100. For example, the external apparatus may include a wired or wireless headset port, an external power supply (or battery charger) port, a wired or wireless data port, a storage card port, a port configured to connect to an apparatus having an identification module, an audio input/output (I/O) port, a video I/O port, a headset port, and the like. The interface unit 108 may be configured to receive input (for example, data information and power) from the external apparatus and transmit the received input to one or more elements in the electronic device 100, or may be configured to transmit data between the electronic device 100 and the external apparatus.

The memory 109 may be configured to store a software program and various data. The memory 109 may mainly include a program storage area and a data storage area. The program storage area may store an operating system, an application program required by at least one function (such as a sound play function or an image play function), and the like. The data storage area may store data (such as audio data or an address book) or the like created according to use of the mobile phone. In addition, the memory 109 may include a high-speed random access memory, and may further include a non-volatile memory such as at least one magnetic disk storage component, a flash memory component, or another volatile solid-state storage component.

The processor 110 is a control center of the electronic device, and is connected to all parts of the entire electronic device by using various interfaces and lines, and performs various functions of the electronic device and processes data by running or executing the software program and/or the module that are stored in the memory 109 and invoking the data stored in the memory 109, to implement overall monitoring on the electronic device. The processor 110 may include one or more processing units. In some embodiments, the processor 110 may be integrated with an application processor and a modem processor. The application processor mainly processes an operating system, a user interface, an application program, and the like, and the modem processor mainly processes wireless communication. It may be understood that the modem processor may also not be integrated into the processor 110.

The electronic device 100 may further include a power supply 111 (such as a battery) that supplies power to each component. In some embodiments, the power supply 111 may be logically connected to the processor 110 by using a power management system, to implement functions such as charging, discharging, and power consumption management by using the power management system.

In addition, the electronic device 100 includes some function modules not shown, and details are not described herein.

For example, an embodiment of this application further provides an electronic device 100, including, as shown in FIG. 10, a processor 110, a memory 109, and a program or an instruction that is stored in the memory 109 and that can run on the processor 110. In a case that the program or the instruction is executed by the processor 110, processes of the embodiment of the text language type switching method can be implemented, and a same technical effect can be achieved. To avoid repetition, details are not described herein.

An embodiment of this application further provides a computer-readable storage medium. A computer program is stored in the computer-readable storage medium. In a case that the computer program is executed by a processor, processes of the embodiment of the text language type switching method can be implemented, and a same technical effect can be achieved. To avoid repetition, details are not described herein. The computer-readable storage medium includes a Read-Only Memory (ROM), a Random Access Memory (RAM), a magnetic disk, an optical disc, or the like.

It should be noted that in this specification, the term “include”, “including”, or any other variant is intended to cover non-exclusive inclusion, so that a process, method, article, or apparatus that includes a series of elements includes not only those elements but also other elements that are not explicitly listed, or includes elements inherent to such a process, method, article, or apparatus. In the absence of more restrictions, an element defined by the statement “including a . . . ” does not exclude another same element in a process, method, article, or apparatus that includes the element.

According to the descriptions of the foregoing implementations, a person skilled in the art may clearly understand that the foregoing method embodiments may be implemented by using software and a required universal hardware platform, or may be implemented by using hardware. In some embodiments, the technical solutions of the present disclosure essentially or the part contributing to existing technologies may be implemented in a form of a software product. The computer software product is stored in a storage medium (such as a ROM/RAM, a magnetic disk, or an optical disc) and includes several instructions for instructing a terminal (which may be a mobile phone, a computer, a server, an air conditioner, or a network device) to execute the methods described in the embodiments of the present disclosure.

The embodiments of the present disclosure are described with reference to the accompanying drawings. However, the present disclosure is not limited to the foregoing specific implementations. The foregoing specific implementations are merely examples, but are not limiting. A person of ordinary skill in the art may make many forms without departing from the objective and the scope of the claims of the present disclosure, and these forms all fall within the protection scope of the present disclosure.

1. A text language type switching method, comprising:
receiving a typing input of a user;
displaying a first text segment in response to the typing input;
receiving a first input of the user;
determining a to-be-switched text segment of a first language type from the first text segment in response to the first input;
receiving a second input of the user; and
switching the to-be-switched text segment to a target text segment of a second language type in response to the second input.

2. The text language type switching method according to claim 1,
wherein:
the typing input comprises a first typing sub-input,
the displaying a first text segment in response to the typing input comprises:
determining an original text segment according to the first typing sub-input, and determining the to-be-switched text segment of the first language type corresponding to the original text segment, and
the switching the to-be-switched text segment to a target text segment of a second language type comprises:
determining, according to the original text segment corresponding to the to-be-switched text segment, a target text segment of the second language type corresponding to the original text segment.

3. The text language type switching method according to claim 2, wherein
in a case that the first language type is English, the to-be-switched text segment is the original text segment; and
in a case that the second language type is English, the target text segment is the original text segment.

4. The text language type switching method according to claim 2, wherein in a case that the original text segment corresponds to a text segment of at least one second language type, the determining, according to the original text segment corresponding to the to-be-switched text segment, a target text segment of the second language type corresponding to the original text segment comprises:
displaying the text segment of at least one second language type that matches the original text segment corresponding to the to-be-switched text segment;
receiving a third input of the user; and
determining the target text segment of the second language type from the text segment of at least one second language type in response to the third input.

5. The text language type switching method according to claim 1, wherein the first text segment comprises at least two sub-text segments that are sequentially input by the user, and the determining a to-be-switched text segment of a first language type from the first text segment in response to the first input comprises:
determining, according to a target type of the first input, a target sequence number corresponding to the target type, and determining a sub-text segment corresponding to the target sequence number that is in the at least two sub-text segments as the to-be-switched text segment.

6. The text language type switching method according to claim 5, further comprising determining the sub-text segment, comprising:
in a case that an input event of acknowledgment text is monitored, determining, as the sub-text segment, text between latest input text and text that is input for the first time after the input event is previously monitored.

7. The text language type switching method according to claim 1, wherein the switching the to-be-switched text segment to a target text segment of a second language type in response to the second input comprises:
switching the to-be-switched text segment to a target text segment of the second language type, and switching a cursor to the end of a displayed text segment in response to the second input.

8. An electronic device, comprising a memory having a computer program stored thereon;
and a processor, wherein the computer program, when executed by the processor, causes the processor to perform a text language type switching method, comprising:
receiving a typing input of a user;
displaying a first text segment in response to the typing input;
receiving a first input of the user;
determining a to-be-switched text segment of a first language type from the first text segment in response to the first input;
receiving a second input of the user; and
switching the to-be-switched text segment to a target text segment of a second language type in response to the second input.

9. The electronic device according to claim 8,
wherein:
the typing input comprises a first typing sub-input,
the displaying a first text segment in response to the typing input comprises:
determining an original text segment according to the first typing sub-input, and determining the to-be-switched text segment of the first language type corresponding to the original text segment, and
the switching the to-be-switched text segment to a target text segment of a second language type comprises:
determining, according to the original text segment corresponding to the to-be-switched text segment, a target text segment of the second language type corresponding to the original text segment.

10. The electronic device according to claim 9, wherein
in a case that the first language type is English, the to-be-switched text segment is the original text segment; and
in a case that the second language type is English, the target text segment is the original text segment.

11. The text language type switching method according to claim 9, wherein in a case that the original text segment corresponds to a text segment of at least one second language type, the determining, according to the original text segment corresponding to the to-be-switched text segment, a target text segment of the second language type corresponding to the original text segment comprises:
displaying the text segment of at least one second language type that matches the original text segment corresponding to the to-be-switched text segment;
receiving a third input of the user; and
determining the target text segment of the second language type from the text segment of at least one second language type in response to the third input.

12. The electronic device according to claim 8, wherein the first text segment comprises at least two sub-text segments that are sequentially input by the user, and the determining a to-be-switched text segment of a first language type from the first text segment in response to the first input comprises:
determining, according to a target type of the first input, a target sequence number corresponding to the target type, and determining a sub-text segment corresponding to the target sequence number that is in the at least two sub-text segments as the to-be-switched text segment.

13. The electronic device according to claim 12, wherein the method further comprises determining the sub-text segment, comprising:
in a case that an input event of acknowledgment text is monitored, determining, as the sub-text segment, text between latest input text and text that is input for the first time after the input event is previously monitored.

14. The electronic device according to claim 8, wherein the switching the to-be-switched text segment to a target text segment of a second language type in response to the second input comprises:
switching the to-be-switched text segment to a target text segment of the second language type, and switching a cursor to the end of a displayed text segment in response to the second input.

15. A non-transitory computer-readable storage medium storing a computer program or an instruction that, when executed by a processor, causes the processor to perform a text language type switching method, comprising:
receiving a typing input of a user;
displaying a first text segment in response to the typing input;
receiving a first input of the user;
determining a to-be-switched text segment of a first language type from the first text segment in response to the first input;
receiving a second input of the user; and
switching the to-be-switched text segment to a target text segment of a second language type in response to the second input.

16. The non-transitory computer-readable storage medium according to claim 15,
wherein:
the typing input comprises a first typing sub-input,
the displaying a first text segment in response to the typing input comprises:
determining an original text segment according to the first typing sub-input, and determining the to-be-switched text segment of the first language type corresponding to the original text segment, and
the switching the to-be-switched text segment to a target text segment of a second language type comprises:
determining, according to the original text segment corresponding to the to-be-switched text segment, a target text segment of the second language type corresponding to the original text segment.

17. The non-transitory computer-readable storage medium according to claim 16, wherein
in a case that the first language type is English, the to-be-switched text segment is the original text segment; and
in a case that the second language type is English, the target text segment is the original text segment.

18. The text language type switching method according to claim 16, wherein in a case that the original text segment corresponds to a text segment of at least one second language type, the determining, according to the original text segment corresponding to the to-be-switched text segment, a target text segment of the second language type corresponding to the original text segment comprises:
displaying the text segment of at least one second language type that matches the original text segment corresponding to the to-be-switched text segment;
receiving a third input of the user; and
determining the target text segment of the second language type from the text segment of at least one second language type in response to the third input.

19. The non-transitory computer-readable storage medium according to claim 15, wherein the first text segment comprises at least two sub-text segments that are sequentially input by the user, and the determining a to-be-switched text segment of a first language type from the first text segment in response to the first input comprises:
determining, according to a target type of the first input, a target sequence number corresponding to the target type, and determining a sub-text segment corresponding to the target sequence number that is in the at least two sub-text segments as the to-be-switched text segment.

20. The non-transitory computer-readable storage medium according to claim 19, wherein the method further comprises determining the sub-text segment, comprising:
in a case that an input event of acknowledgment text is monitored, determining, as the sub-text segment, text between latest input text and text that is input for the first time after the input event is previously monitored.
